(19) United States
(12) Patent Application Publication
(10) Pub. No.: US 2007/0058836 A1
(43) Pub. Date: Mar. 15, 2007

(54) Object classification in video data

(75) Inventors: Lokesh R. Boregowda, Bangalore (IN); Anupama Rajagopal, Coimbatore (IN)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc.

(21) Appl. No.: 11/227,505

(22) Filed: Sep. 15, 2005

(51) Int. Cl. G06K 9/00; G06K 9/62

(52) U.S. Cl. 382/103; 382/224

(57) ABSTRACT

A method to classify objects labels objects as human, vehicle, multiple human, or other based on output from a motion detection algorithm. Features that are extracted from the blob, such as size, shape, and area, form a basis of the classification. The extracted features are subjected to various mathematical analyses that distinguish the classes that are available for labeling an object.

### TECHNICAL FIELD

Various embodiments of the invention relate to the field of classifying objects in video data.

### BACKGROUND

Object classification in video data involves labeling an object as a human, a vehicle, multiple humans, or as an “Other” based on a binary blob input from the output of a motion detection algorithm. In general, the features of the blob are extracted and form a basis for a classification module, and the extracted features are subjected to various mathematical analyses that determine the label to be applied to the blob (i.e. human, vehicle, etc.).

Such classification has been addressed using a variety of methods based on supervised and/or unsupervised classification theories such as Bayesian Probability, Neural Networks, and Support Vector Machines. Up to this point in time, the applicability of these methods however has been restricted to typical ideal scenarios such as those depicted in standard video databases that are available online from various sources. However, the challenges posed by realistic video datasets and/or application scenarios have gone unaddressed in many such classification methods.

Some of the challenges in such real-life scenarios include:
The size and shape of an object continually varies as the object moves in the field of view.
The actual properties of an object are difficult to determine when the object is located a substantial distance from the device capturing the image.
Information regarding an object may be incomplete when the object is located relatively close to the device capturing the image (due, for example, to occlusions).
The properties of an object may be distorted due to varying illumination conditions in the field of view.
The properties of an object may also be distorted due to shadows and reflections in the field of view.
The properties of an object may vary depending largely on the speed of the object.
The properties of an object may be distorted due to the position and/or angle of the device capturing the image.
The classification of an object should be done almost instantaneously.
An object that is identified as moving due to “false motion detection” needs to be classified as “others” or “unknown” (not human, vehicle, etc.).
The object properties for humans, vehicles, and other classes overlap depending on the object's mode of entry into the scene (Region-Of-Interest (ROI)) and also on the size, shape, and position of the Region-of-Interest.

Existing methods for object classification extract one or more features from the object and use a neural network classifier or modeling method for analyzing and classifying based on the features of the object. In each method the extracted features and the classifier or method used for analyzing and classifying depends on the particular application. The accuracy of the system depends on the feature type and the methodology adopted for effectively using those features for classification.

In one method, a consensus is obtained from the individual input from a number of classifiers. The method detects a moving object, extracts two or more features from the object, and classifies the object based on the two or more features using a classifier. The features extracted include the x-gradient, y-gradient and the x-y gradient. The classification method used is the Radial Basis Function Network for training and classifying a moving object.

Another object classification method known in the art uses features such as the object's area, the object's percentage occupancy of the field of view, the object's direction of motion, the object's speed, the object's aspect ratio, and the object's orientation as vectors for the classifier. The different features used in this method are labeled as scene-variant, scene-specific and non-informative features. The instance features are used to arrive at a class label for the object in a given image and the labels are observed in other frames. The observations are then used by a discriminative model—support vector machine (SVM) with soft margin and Gaussian kernel—as the instance classifier for obtaining the final label. This classifier suffers from high computational complexity in the algorithm.

In a further classification method known in the art, the classification is done in a simpler and less efficient way using only the height and width of an object. The ratio of height and width of each bounding box is studied to separate pedestrians and vehicles. For a vehicle, this value should be less than 1.0. For a pedestrian, this value should be greater than 1.5. To provide flexibility for special situations such as a running person or a long or tall vehicle, if the ratio is between 1.0-1.5, then the information from the corner list of this object is used to classify it as a vehicle or a pedestrian (i.e., a vehicle produces more corners).

Another classification scheme uses a Maximum Likelihood Estimation (MLE) to classify objects. In MLE, a classification metric is computed based on the dispersion and the total area of the object. The dispersion is the ratio of the square of the perimeter and the area. This method has difficulty classifying multiple humans as humans and may label them as a vehicle. While in this method the classification metric computation is computationally inexpensive, the estimation technique tends to decrease the speed of the algorithm.

In a slightly different approach to classifying objects, a method known in the art is a system that consists of two major parts—a database containing contour-based representations of prototypical video objects and an algorithm to match extracted objects with those database representations. The objects are matched in two steps. In the first, each automatically segmented object in a sequence is compared to all objects in the database, and a list of the best matches is built for further processing. In the second step, the results are accumulated and a confidence value is calculated. Based on the confidence value, the object class of the object in the sequence is determined. Problems associated with this method include the need for a large database with consequent extended retrieval times, and the fact that the selection of different prototypes for the database is difficult.

Thus, in the techniques known in the art for object classification, a major emphasis is placed on obtaining the classification accurately by employing very sophisticated estimation techniques while the features that are extracted are considered to be secondary. The art is therefore in need of a novel method to classify objects in video data that does not follow this school of thought of the known techniques.

### BRIEF DESCRIPTION OF THE DRAWINGS

FIG. 1 illustrates a flowchart of an example embodiment of a video data object classifier.

FIG. 2 illustrates feature details of an example embodiment of a video data object classifier.

FIG. 3 illustrates an example of a rotation process as applied to a blob in a video data object classifier.

FIG. 4 illustrates length-width ratio ranges for vehicles, humans, multiple humans, and other objects.

FIG. 5 illustrates an output from an example embodiment of a video data object classifier.

### DETAILED DESCRIPTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

In an embodiment, an object classification system for video data emphasizes features extracted from an object rather than the actual methods of classification. Consequently, in general, the more features associated with an object—the more accurate the classification will be. Once the features are extracted from an object in an image, the classification of that object (e.g., human, vehicle, etc.) involves a simple check on a range of values based on those features.

The algorithm of an embodiment is referred to as a statistical weighted average decision (SWAD) classifier. Compared to other systems known in the art, the SWAD is not very computationally complex. This lack of complexity exploits statistical properties, as well as shape properties, as captured by a plurality of representative features drawn from different theoretical backgrounds such as shape descriptors in medical image classification, fundamental binary blob features such as those in template matching, and contour distortion features. The SWAD classifies the given binary object blobs into a human, a vehicle, an other, or an unknown classification.

In an embodiment, motion segmented results obtained from a Video Motion Detection (VMD) module coupled with a track label from a Video Motion Tracking (VMT) module form the inputs to an object classification (OC) module. The OC module extracts the blob features and generates a classification confidence for the object along the entire existence of the object in the scene or region of interest (ROI). The label (human, vehicle) obtained after attaining a sufficiently high-level of classification confidence is termed as the true class label for the object. The confidence is built temporally based on the consistency of the features generated from the successive frame object blobs associated with each unique tracked object.

These feature range values overlap for different types of blobs. Depending on the percentage of overlap, weighted values are assigned to the feature ranges of each of the classes (human, vehicle, others). These weighted values are used as scaling factors along with feature dynamic range values to formulate a voting scheme (unit-count voting and weighted-count voting) for each class—human/vehicle/others. Based on the voting results and with few heuristic strengthening, a normalized class confidence measure value is derived for the blob to be classified as human, vehicle, or other. Based on an experimental embodiment, a class confidence of 60% is sufficient (to account for the real-life scenarios mentioned above) to give a final class-label decision for each tracked object.

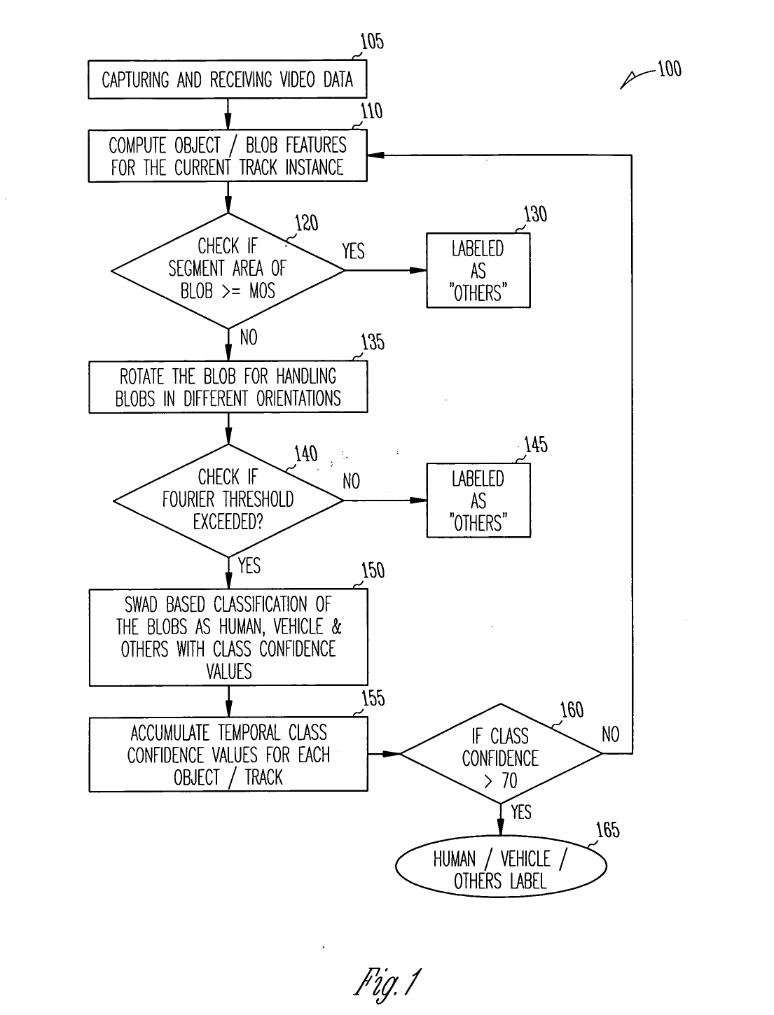

FIG. 1 illustrates an embodiment of the SWAD process 100 used to classify an object. An overall strategy for classification involves a first stage of blob-disqualification—i.e., if certain conditions are not met, the blob is classified as an “other.” Referring to FIG. 1, video data is received from an image capturing device at 105, and blob features of an object are computed at 110 for a current track instance. The resulting binary blob is then tested at 120 for a qualifying Minimum Object Size (MOS). If the binary blob is less than a minimum object size, it is classified as “Others” at 130. In one embodiment, the binary blob is then rotated at 135 so that it can be handled (i.e. MOS calculated) in different orientations. Blobs that satisfy the MOS condition are subjected to another level of pre-classification analysis involving a Fourier analysis based algorithm at 140 to derive a Fourier magnitude threshold to further sift out “Others” type class blobs (145). Finally, a last stage comprises the core blob-feature extraction phase (150, 155) followed by a decision stage for classifying and assigning class labels for blobs as Human (H), Vehicle (V), Multiple Human (M), and Others (O) (160, 165).

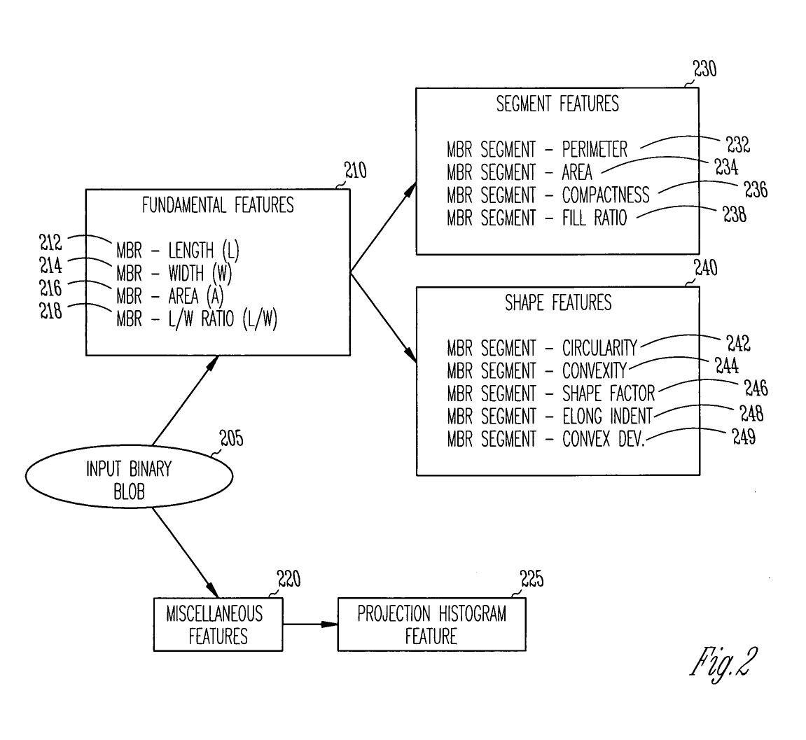

Referring to FIG. 2, in an embodiment, features extracted from an input blob 205 include fundamental features 210 and miscellaneous features 220. The fundamental features include minimum bounding rectangle (MBR) features such as the length L (212) of the blob MBR, the width W (214) of the blob MBR, the area 216 MBR-A of the MBR (L·W), and a length to width ratio 218 (L-W Ratio). The fundamental features 210 are divided into segment features 230 and shape features 240. The segment features 230 include a perimeter 232 (Seg-P) of the blob, an area 234 (Seg-A) of the blob (or count of the blob pixels), the compactness 236 (Seg-Comp) of the blob (ratio of the perimeter to the area), and a fill ratio 238 (Seg-FR) of the blob (ratio of Seg-A to MBR-A). The shape features 240 include circularity 242 (Seg-Circ) (measure of the perimeter circularity), convexity 244 (Seg-Conv) (measure of perimeter projections), shape factor 246 (Seg-SF) (measure of perimeter shape variation), elongation-indentation 248 (Seg-EI) (measure of the spread of the blob), and convex deviation 249 (Seg-Dev) (ratio of Seg-Conv and Seg-SF). The miscellaneous features 220 include a projection histogram feature 225 (Seg-PH) (a measure of the quadrant-wise shape).

The features in FIG. 2 are calculated and then normalized with respect to the frame size (since the feature ranges may differ for different image resolutions). The fundamental features are calculated at block 210. The length 212 and width 214 of the blob 205 are computed based on the extreme white pixels in the MBR. The normalized area is computed by multiplying the normalized length by the normalized width. The L-W ratio 218 is the ratio of the normalized length and normalized width of the blob. The normalized, with respect to frame resolution, length, width, area, and length-width ratio are calculated as follows:
Normalized MBR Length=MBR Length/Blob Rows;
Normalized MBR Width=MBR Width/Blob Columns;
Normalized MBR Area=Normalized MBR Length*Normalized MBR Width;
Normalized MBR L-W Ratio=Normalized MBR Length/Normalized MBR Width.
The blob rows and blob columns represent the number of pixels that the blob occupies in its length and width respectively.

The segment features are derived from the length 212, width 214, and area 216. The MBR SegPerimeter may be determined by summing the number of white pixels around the perimeter of the binary image. Similarly, the MBR SegArea may be determined by summing the total number of white pixels in the binary image. The features segment compactness 236 and fill ratio 238 are strong representations of the blob's density in the MBR. All these values are also normalized with respect to the image size.
Norm MBR SegPerimeter=MBR SegPerimeter/(2*(Blob Columns+Blob Rows))
Norm MBR SegArea=MBR SegArea/(Blob Columns*Blob Rows)
MBR SegComp=(MBR SegPerimeter*MBR SegPerimeter)/MBR SegArea
MBRFillRatio=MBR SegArea/MBR Area

The shape features 240 such as the circularity 242, convexity 244, and elongation indent 248 are computed using the segment area 234 and the perimeter 232.
MBR SegCircularity=4*PI*MBR SegArea/(MBR SegPerimeter)²
MBR SegConvexity=MBR SegPerimeter/sqrt(MBRSegArea)
MBR SegSFactor=MBRSegArea/(MBRSegPerimeterˆ0.589)
MBR ElongIndent=sqrt(CoSqr+SfSqr)
Where,
CoSqr=MBR SegConvexity*MBR SegConvexity
SfSqr=MBR SegSFactor*MBR SegSFactor
   MBRSF2ConvexDev=atan(MBRSegSFactor/MBRSegConvexity)

The computation of miscellaneous features captures class-dependent information and/or variations for the human and vehicle classes. They use row and column projection histograms on the blobs.

A projection histogram feature 225 provides a distinct measure for classifying the blobs, as the histogram values represent the shape of the object. The blob is split into four quadrants and the Row and Column projection histograms are calculated. The Standard Deviation of these projection histogram values is weighted from which the representative feature value is calculated.

In an embodiment, the Minimum Object Size (MOS) is calculated using the focal length of the image capturing device, and the vertical and horizontal distance that the object is from the device. The MOS is then used as an initial determiner of whether to classify a blob as an “Other.” The following are the measurement values used in calculating the MOS.
Total Field of View (FOV)=2 tan⁻¹(d/2f)
d—Sensitivity area,
f—Focal Length of the Camera
   Camera to Object Range=Sqrt[(HDist)²+(VDist)²]
HDist—Horizontal Distance from the Camera,
VDist—Vertical Distance from the Camera.
   Angle at camera (theta)=(X/R) in degrees
X—Standard Size (Length/Width) of an Object,
R—Camera to Object Range.
   No. of pixels occupied by the object along the vertical/horizontal axis=theta/FOV
theta—Angle at Camera,
FOV—Field of View
   The above calculations are done for the Length 212 and Width 214 of the object separately to obtain the MOS for the length and MOS for width respectively.

The binary blobs may be misclassified due to non-availability of direction information. This is due to the varied aspect ratios of the blobs depending on their direction of motion in the scene. Hence all the blobs should be similarly oriented with respect to the center before classification. To account for this, rotation handling 135 is a pre-processing step in object classification.

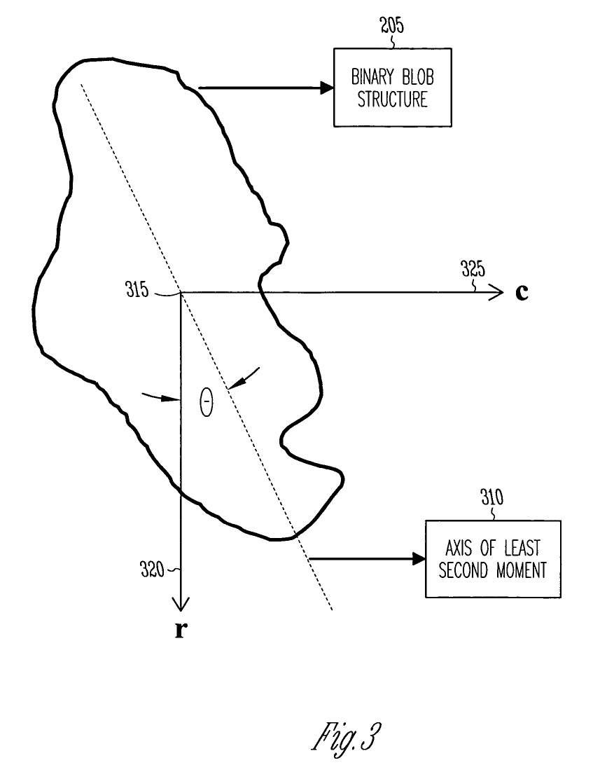

In an embodiment as illustrated in FIG. 3, the axis of least second moment 310 is used to provide information about the object's orientation. The axis of least second moment corresponds to the line about which it takes the least amount of energy to spin an object of like shape (or the axis of least inertia). For the origin at the center 315 of the area (r, c) (320, 325), the axis of least second moment is defined as follows:

$$Tan ( 2 θ ) = 2 \frac{ΣΣ rcI ( r , c )}{{ΣΣr}^{2} I ( r , c ) - {ΣΣc}^{2} I ( r , c )}$$

where r represents the number of rows (i.e. length) occupied by the image, c represents the number of columns (i.e. width) occupied by the image, and I(r,c) represents the center location in an image I. The summations in the numerator and denominator above are over the rows and columns of the image (i.e., 1 to the number of rows and 1 to the number of columns).

In an embodiment, the next step involves a first level classification of the blob 205. A rotated blob is subjected to a first level of analysis in which it is determined if the MBR Area of the blob satisfies the Normalized MOS. If the blob satisfies the MOS condition, it is subjected to another level of analysis for classifying as Others (otherwise the blob is labeled as Others). The another level of analysis includes verifying the fundamental feature values of the blob and using the Fourier analysis to verify whether the given blob falls under the category of Others. The fundamental features used in the first level of classification include the L/W Ratio, Segment Perimeter, Segment Compactness and Fill Ratio.

The algorithm for the Fourier based analysis for the Others classification is as follows. The input blob boundaries are padded with zeros twice, and the image is resized to a standard size. In one embodiment, that standard size is 32 by 32 pixels. The magnitude of the radix-2 Fast Fourier Transform on the resized image is calculated, and the normalized standard deviation of the FFT magnitudes is computed. A threshold value is defined for the standard deviation, and the standard deviation is computed and compared against the defined threshold.

After completing the first level of classification (in which the blob may be classified as “Others”), a second level of classification is applied to the blob. The derived features such as the circularity 242, convexity 244, elongation indent 248, and the projection histogram features 225 are computed for the second level of classification of the blob. In this second classification, ranges that the features may fall into for a class (human, vehicle, etc.) are defined, and class weights are derived based on overlap made by feature ranges for the different classes.

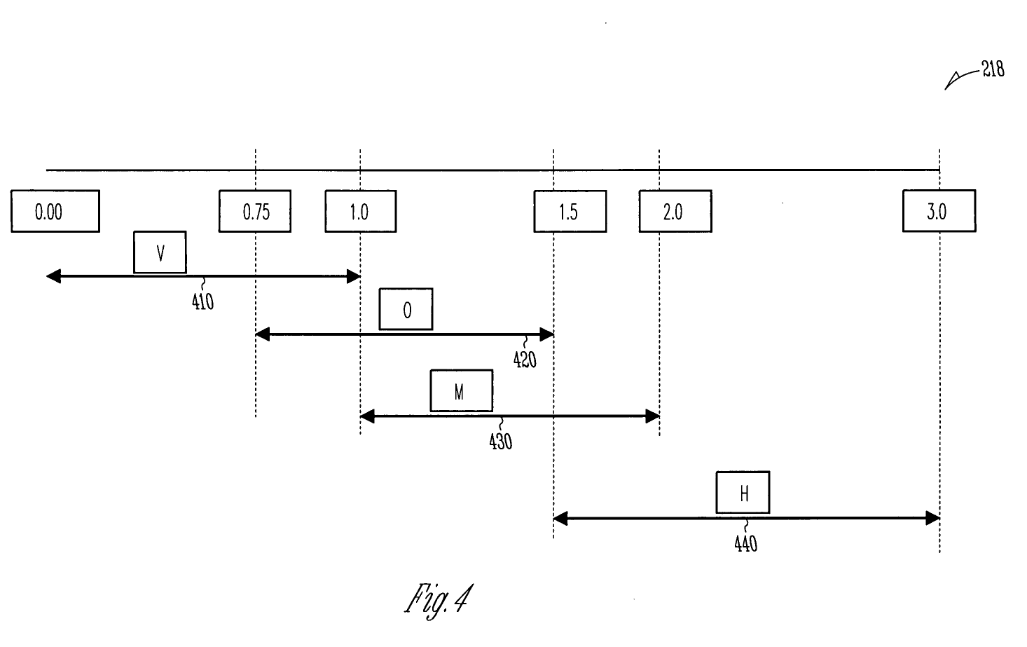

For example, referring to FIG. 4, for the feature L/W Ratio 218 (having range 0.0 to 3.0 in this example), the feature ranges are defined as 0 to 1.0 for a vehicle (410), 0.75 to 1.5 for “Other” (420), 1.0 to 2.0 for multiple humans (430), and 1.5 to 3.0 for humans (440). From these ranges, the derived weights are calculated as follows.

For vehicles, the range 0.0 to 0.75 has no overlap with any other classes, so a direct weight of 0.75 is derived for vehicles. The rest of the vehicle range, 0.75 to 1.0, overlaps with the OTHER class range. Therefore, a value of 0.125 (by distributing the overlap range value 0.25 equally to the overlapping classes) is added to the direct weight value of 0.75. Consequently, the Vehicle Derived Weight Calculation is as follows:
Total Derived Weight for Vehicle (DWV)=0.75+0.125=0.875
Percentage Derived Weight (PDW)=(0.875/3.0)*100=29.2

For OTHERS the range from 1.0 to 1.5 has overlap with the Multiple Human class. Therefore, a weight value of 0.25 (dividing 0.5 by 2) is included in the derived weights. Also the range from 0.75 to 1.0 overlaps with the vehicle class. So a weight value of 0.125 (distributing the overlap range value 0.25 equally to the overlapping classes) is added to the derived weights calculation. The OTHERS Derived Weight Calculation is as follows:
Total Derived Weight for Others (DWO)=0.25+0.125=0.375
Percentage Derived Weight (PDWO)=(0.375/3.0)*100=12.5

For the Multiple Human category, the range 1.0 to 1.5 overlaps with the OTHER class. Hence, 0.25 (distributing the overlap range value 0.5 equally to the overlapping classes) is included in the derived weights. Also, the range from 1.5 to 2.0 overlaps with the HUMAN class. So a weight value of 0.25 (distributing the overlap range value 0.5 equally to the overlapping classes) is added to the derived weights. The Multiple Human Derived Weight Calculation is as follows:
Total Derived Weight for Multiple Human (DWM)=0.25+0.25=0.5
Percentage Derived Weight for Multiple Human (PDWM)=(0.5/3.0)*100=16.66

For the HUMAN range, 1.5 to 2.0 overlaps with the Multiple Human class. Hence, 0.25 (distributing the overlap range value 0.5 equally to the overlapping classes) is included in the derived weights. A value of 1.0 is added to the derived weights for the range 2.0 to 3.0. The Human Derived Weight Calculation is as follows:
Total Derived Weight for Human (DWH)=0.25+1.0=1.25
Percentage Derived Weight for Human (PDWH)=(1.25/3.0)*100=41.66

The derived weights for this example are summarized below:
OTHERS (O)—12.5
HUMAN (H)—41.6
VEHICLE (V)—29.2
MULHUMAN (M)—16.7

The derived features from the blob 205 are validated with respect to the predefined human 440, vehicle 410, multiple human 430, and other (420) ranges as illustrated by example in FIG. 4. Vote counts are then tabulated for a blob. A vote count for a class is incremented if the derived feature value lies in the predefined range of that class. After each feature is considered, there is a vote count for all classes. After the vote count is complete, a weight count vote value for human, vehicle, multiple human, and other is derived. The weight count vote and vote count values are then converted to percentage ranges. A set of heuristics is applied to decide on the class to which the blob belongs. A class confidence value is then calculated. The weight count vote, vote-count and the class confidence values over the frames for a given tracked object are combined giving the corresponding class label and its class confidence. The assigned class label is confirmed if class confidence exceeds a value of 70%.

Specifically, in an embodiment, starting with the features extracted from the binary object blobs (i.e. MBR Length, MBR Width, MBR Area, etc.), initialize the values for the minimum and maximum of all features for the four classes of objects—“Human (H)”, “Vehicle (V)”, “Others (O)” and “Multiple Human (M)”. Then, for a given binary object blob that is to be classified, the following steps are performed. The feature values of the binary object blob are computed and compared against the feature value ranges for all classes and for all features. If the feature value of the blob under consideration falls in a range of a particular class, then the blob gets a “vote” for that class. These are referred to as Unit-Count votes. Then, the Unit-Count (UC) votes are accumulated for all feature values for all classes. A Weighted Unit-Count (WUC) votes is generated by multiplying the UC votes obtained above with the pre-determined feature weight-age values.

The UC and WUC votes are then summed class-wise for the binary blob under consideration. This gives us the scores corresponding to the UC and WUC for each of the classes for the given binary blob. These scores may be referred to as Scores-UC (SUC) and Scores-WUC (SWUC).

The SUC and SWUC values of each of the four classes are converted into percentage values using the following equations (following are the equations for H class):
Percentage SUC for H=PSUC_H=SUC_H/(sum of SUC for 4 classes)
A similar computation is done to obtain PSUC_H, PSUC_O & PSUC_M, and a similar computation is done to obtain the class-wise Percentage SWUC's, i.e., PWSUC_H, PWSUC_V, PWSUC_O & PWSUC_M.

Then, the final class score for the binary object blob is computed as follows:
a. Class_H_Score=(PWSUC_H+(PSUC_H/2.0));
b. Class_V_Score=(PWSUC_V+(PSUC_V/2.0));
c. Class_O_Score=(PWSUC_O+(PSUC_O/2.0));
d. Class_M_Score=(PWSUC_M+(PSUC_M/2.0)).

The given binary blob is then given the class label based on which of the above four scores is highest. This class label is treated as the class label for the current instance (which is occurring in the current frame of the video sequence) of the moving object in the video scene. The final class label is then arrived at as follows. The scores thus obtained per occurrence instance are accumulated over the sequence of video frames wherein the moving object exists. A class confidence value is computed depending on the number of instances the binary object blob has identical class labels. For example, in the following case:
Frame 1, i.e., first occurrence of object—Declared class label is H
Frame 2, i.e., second occurrence of object—Declared class label is V
Frame 3, i.e., third occurrence of object—Declared class label is H
Frame 4, i.e., fourth occurrence of object—Declared class label is H
Frame 5, i.e., fifth occurrence of object—Declared class label is H
Then the class confidence for the four classes for the object under consideration, after five frames or instances of occurrence, would be:

$$\begin{matrix}H Class confidence = ( No . of times object was labeled H * 100 ) \\ = ( 4 * 100 / 5 ) \\ = 80 \%\end{matrix}$$

Similarly, V Class Confidence=(1*100/5)=20%
O Class Confidence=(0*100/5)=0%
M Class Confidence=(0*100/5)=0%
The final class label of the object is declared as that class for which the above computed class confidence crosses a fixed threshold value of 75%. In the above example considered, the object blob being analyzed would be classified as a H (i.e., HUMAN) since the class confidence has crossed the fixed confidence threshold of 75%.

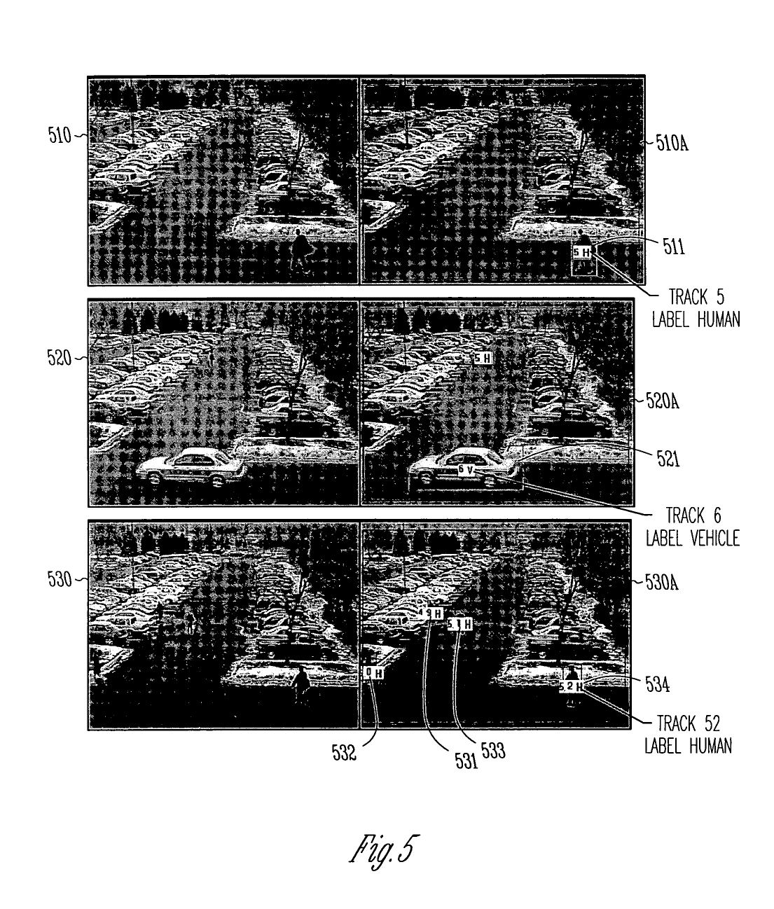

FIG. 5 illustrates an example of three input images 510, 520, and 530 along with their respective output images 510a, 520a, and 530a after the objects in the images have been assigned output labels. As seen if FIG. 5, a human 511 has been identified in track 5 in 510a, a vehicle 521 has been identified in track 6 in 520a, and humans 531-534 have been identified in tracks 49, 50, 51, and 52 in 530a.

In the foregoing detailed description of embodiments of the invention, various features are grouped together in one or more embodiments for the purpose of streamlining the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims are hereby incorporated into the detailed description of embodiments of the invention, with each claim standing on its own as a separate embodiment. It is understood that the above description is intended to be illustrative, and not restrictive. It is intended to cover all alternatives, modifications and equivalents as may be included within the scope of the invention as defined in the appended claims. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein,” respectively. Moreover, the terms “first,” “second,” and “third,” etc., are used merely as labels, and are not intended to impose numerical requirements on their objects.

The abstract is provided to comply with 37 C.F.R. 1.72(b) to allow a reader to quickly ascertain the nature and gist of the technical disclosure. The Abstract is submitted with the understanding that it will not be used to interpret or limit the scope or meaning of the claims.

1. A method comprising:
receiving data regarding video motion detection and video motion tracking of an object;
identifying a blob in said data;
extracting fundamental features from said blob;
extracting miscellaneous features from said blob;
determining whether said blob meets a minimum object size;
applying a Fourier analysis to said blob, thereby producing a Fourier magnitude threshold;
providing one or more classifications for said blob;
computing a statistical weighted average for said one or more classifications based on said fundamental features and said miscellaneous features; and
computing a class confidence value for said one or more classifications.

2. The method of claim 1, further comprising:
rotating said blob; and
determining whether said Fourier magnitude threshold is exceeded.

3. The method of claim 1, wherein said blob does not satisfy said minimum object size, and further comprising labeling said blob as an other classification.

4. The method of claim 1, wherein said blob does not exceed said Fourier magnitude threshold, and further comprising labeling said blob as an other classification.

5. The method of claim 1, wherein said class confidence value exceeds a threshold for said one or more classifications, and further comprising assigning a label to said blob, thereby identifying said blob as a member of said one or more classifications.

6. The method of claim 1,
wherein said fundamental features include minimum bounding rectangle features (MBR) comprising an MBR length of said blob, an MBR width of said blob, an MBR area of said blob, and an MBR length to width ratio of said blob; and
wherein said miscellaneous features include a projection histogram.

7. The method of claim 6,
wherein said fundamental features further comprise segment features and shape features, and further
wherein said segment features comprise an MBR segment perimeter of said blob, an MBR segment area of said blob, an MBR segment compactness of said blob, and an MBR fill ratio of said blob; and
wherein said shape features comprise an MBR segment circularity of said blob, an MBR segment convexity of said blob, an MBR segment shape factor of said blob, an MBR segment elongation-indentation of said blob, and an MBR segment convex deviation of said blob.

8. The method of claim 6, further comprising:
calculating a normalized MBR length by dividing said MBR length by the number of pixel rows of said blob;
calculating a normalized MBR width by dividing said MBR width by the number of pixel columns of said blob;
calculating a normalized MBR area by multiplying said normalized MBR length by said normalized MBR width; and
calculating a normalized MBR length to width ratio by dividing said normalized MBR length by said normalized MBR width.

9. The method of claim 7, further comprising;
calculating a normalized MBR segment perimeter comprising
normalized MBR segment perimeter=(MBR segment perimeter)/(2*(blob pixel columns+blob pixel rows));
calculating a normalized MBR segment area comprising
normalized MBR segment area=(MBR segment area)/(blob pixel columns+blob pixel rows);
calculating a normalized MBR compactness comprising:
normalized MBR segment compactness=(MBR segment perimeter)²/MBR segment area; and
calculating an MBR fill ratio comprising
MBR fill ratio=MBR segment area/MBR area.

10. The method of claim 7, further comprising:
calculating an MBR segment circularity comprising
MBR segment circularity=(4*pi*MBR segment area)/ (MBR segment perimeter)²;
calculating an MBR segment convexity comprising
MBR segment convexity=MBR segment perimeter/(MBR segment area)^{1/2};
calculating an MBR segment shape factor comprising
MBR segment shape factor=MBR segment area/(MBR segment perimeter)^{0.589};
calculating an MBR elongation indent comprising
MBR elongation indent=[(MBR segment convexity)²+(MBR segment shape factor)²]^{1/2}; and
calculating an MBR segment shape factor convex deviation comprising
MBR segment shape factor convex deviation=arctangent (MBR segment shape factor/MBR segment convexity).

11. The method of claim 1, wherein said minimum object size (MOS) comprises:
MOS=(MBR length/[H²+V²]^{1/2})/(2 tan⁻¹(d/2f));
wherein H is a horizontal distance from said object to an image capturing device;
wherein V is a vertical distance from said object to said image capturing device;
wherein d is the sensitivity area; and
wherein f is a focal length of said image capturing device.

12. The method of claim 1, further comprising calculating an axis of least second moment comprising:
$$Tan ( 2 θ ) = 2 \frac{ΣΣ rcI ( r , c )}{{ΣΣr}^{2} I ( r , c ) - {ΣΣc}^{2} I ( r , c )}$$
wherein r represents the number of pixel rows of said blob;
wherein c represents the number of pixel columns of said blob; and
wherein I(r,c) represents the center location of said blob.

13. The method of claim 1, further comprising:
providing a range of values for each of said classifications; and
associating said object with one of said classifications based on said range of values.

14. The method of claim 6, further comprising:
splitting said blob into four quadrants;
calculating a projection histogram representing said pixel rows;
calculating a projection histogram representing said pixel columns;
computing standard deviation values for said projection histograms;
weighting said projection histogram values; and
calculating values for said fundamental features, said segment features, and said shape features.

15. The method of claim 13, further comprising:
determining overlaps among said range of values;
calculating a total derived weight for said classifications based on a non-overlapping portion of said ranges and said overlapping portion of said ranges;
calculating a percentage derived weight based on said total derived weight and said range of values; and
classifying an object based on said percentage derived weight.

16. A method comprising:
receiving data regarding video motion detection and video motion tracking of an object;
identifying an orientation of said object;
aligning said object based on said orientation;
extracting shape features from said object;
providing limiting ranges for said shape features;
classifying said object based on said limiting ranges; and
labeling said object based on said classification.

17. The method of claim 16, further comprising:
deriving weights for said classification; and
calculating a confidence level for said classification, said confidence level based on said shape features from a plurality of images from said video motion detection data and said video motion tracking data.

18. A computer readable medium comprising instructions thereon for executing a method comprising:
receiving data regarding video motion detection and video motion tracking of an object;
computing a blob from said data;
rotating said blob;
extracting fundamental features from said blob;
extracting miscellaneous features from said blob;
determining whether said blob meets a minimum object size;
applying a Fourier analysis to said blob, thereby producing a Fourier magnitude threshold;
providing one or more classifications for said blob;
computing a statistical weighted average for said one or more classifications based on said fundamental features and said miscellaneous features; and
computing a class confidence value for said one or more classifications.

19. The computer readable medium of claim 18,
wherein said fundamental features include minimum bounding rectangle features (MBR) comprising an MBR length of said blob, an MBR width of said blob, an MBR area of said blob, and an MBR length to width ratio of said blob;
wherein said miscellaneous features include a projection histogram;
wherein said fundamental features further comprise segment features and shape features, and further
wherein said segment features comprise an MBR segment perimeter of said blob, an MBR segment area of said blob, an MBR segment compactness of said blob, and an MBR fill ratio of said blob; and
wherein said shape features comprise an MBR segment circularity of said blob, an MBR segment convexity of said blob, an MBR segment shape factor of said blob, an MBR segment elongation-indentation of said blob, and an MBR segment convex deviation of said blob.

20. The computer readable medium of claim 19, further comprising instructions for:
calculating a normalized MBR length by dividing said MBR length by the number of pixel rows of said blob;
calculating a normalized MBR width by dividing said MBR width by the number of pixel columns of said blob;
calculating a normalized MBR area by multiplying said normalized MBR length by said normalized MBR width;
calculating a normalized MBR length to width ratio by dividing said normalized MBR length by said normalized MBR width;
calculating a normalized MBR segment perimeter comprising
normalized MBR segment perimeter=(MBR segment perimeter)/(2*(blob pixel columns+blob pixel rows));
calculating a normalized MBR segment area comprising
normalized MBR segment area=(MBR segment area)/(blob pixel columns+blob pixel rows);
calculating a normalized MBR compactness comprising:
normalized MBR segment compactness=(MBR segment perimeter)²/MBR segment area;
calculating an MBR fill ratio comprising
MBR fill ratio=MBR segment area/MBR area;
calculating an MBR segment circularity comprising
MBR segment circularity=(4*pi*MBR segment area)/ (MBR segment perimeter)²;
calculating an MBR segment convexity comprising
MBR segment convexity=MBR segment perimeter/(MBR segment area)^{1/2};
calculating an MBR segment shape factor comprising
MBR segment shape factor=MBR segment area/(MBR segment perimeter)^{0.589};
calculating an MBR elongation indent comprising
MBR elongation indent=[(MBR segment convexity)²+(MBR segment shape factor)²]^{1/2}; and
calculating an MBR segment shape factor convex deviation comprising
MBR segment shape factor convex deviation=arctangent (MBR segment shape factor/MBR segment convexity).
